(19) United States
(12) Patent Application Publication
(10) Pub. No.: US 2004/0090783 A1
(43) Pub. Date: May 13, 2004

(54) Tunable light source module

(75) Inventors: Sean Chang, Taoyuan (TW); Ching-Yang Juan, Taoyuan (TW)

Correspondence Address: BACON & THOMAS, PLLC, 625 SLATERS LANE, FOURTH FLOOR, ALEXANDRIA, VA, 22314

(73) Assignee: DELTA ELECTRONICS, INC., Taoyan County (TW)

(21) Appl. No.: 10/396,522

(22) Filed: Mar. 26, 2003

(30) Foreign Application Priority Data
Nov. 11, 2002 (TW) 91133177

(51) Int. Cl. F21V 9/00

(52) U.S. Cl. 362/293; 362/259

(57) ABSTRACT

The invention provides a tunable light source module, which includes a semiconductor light-emitting device, a tunable Fabry-Perot device for filtering the light emitted from the semiconductor light-emitting device and a reflector. By means of the reflector, the light filtered by the Fabry-Perot device will pass through the Fabry-Perot device again and then return to the semiconductor light-emitting device.

### BACKGROUND OF THE INVENTION

1. Field of the Invention

The invention relates to a tunable light source module and, more particularly, to a tunable light source module that utilizes the combination of a tunable Fabry-Perot device and a reflector.

2. Description of the Related Art

In the field of optical communication, the optical fiber system transmits information by the beams generated by a light source, and usually the light source being used is either the laser diode or the light-emitting diode. FIG. 1 is a schematic diagram showing a conventional light source module 100 configured for optical communication. As shown in FIG. 1, the light source module 100 includes a laser diode 102, a focusing lens 104, a diffraction grating 106 and a rotatable reflection mirror 108. The focusing lens 104 collimates the light emitted from the laser diode 102, and then the parallel light beams enter the diffraction grating 106. The diffraction grating 106 allows the light to pass at a specified wavelength through thin film interference. Further, the diffraction grating 106 can be formed by metal coating. When the reflection mirror 108 rotates, the light source module 100 can output light with a desired wavelength with the light being refracted by the diffraction grating 106.

However, if a tunable light source module is designed in a way that its light-emitting device can directly emit light from the emitting surface having a desired output spectrum, the flexibility of applying in the optical communication can be obviously increased and fast modulation can be achieved. Consequently, the efficiency of data transmission can be improved. Moreover, if the light-emitting device can emit extreme narrow bandwidth, it can achieve an effect of preventing the optical signals from entering the adjacent channels (ie, immune to crosstalk).

### SUMMARY OF THE INVENTION

Therefore, the invention is to provide a tunable light source module having the advantages mentioned above, which utilizes the combination of a tunable Fabry-Perot device and a reflector to facilitate its light-emitting device directly emitting light from the emitting surface having a desired output spectrum. The tunable light source module of the invention includes a semiconductor light-emitting device, a Fabry-Perot device for filtering the light emitted from the semiconductor light-emitting device, and a reflector. After having been filtered by the Fabry-Perot device, the light reflects back to the Fabry-Perot device again by the reflector, and then enters the semiconductor light-emitting device. Also, a focusing lens can be placed between the semiconductor light-emitting device and the Fabry-Perot device so that the light emitted by the semiconductor light-emitting device can be collimated.

According to one embodiment of the invention, the reflector is a total reflection mirror. After the Fabry-Perot device has filtered the light emitted from a emitting surface of the semiconductor light-emitting device, the filtered light enters the Fabry-Perot device again by means of the total reflection mirror, and then the light will return to the semiconductor light-emitting device. The tunable light source module will output the light from the other emitting surface of the semiconductor light-emitting device.

According to another embodiment of the invention, the reflector is a partial reflection mirror, which reflects one portion of the light that has been filtered and allows the other portion of the light to pass through. The light that has passed through the partial reflection mirror forms the output light of the tunable light source module, or it can enter a wavelength locker to provide a more precise output wavelength.

Moreover, the focusing lens can be a convex lens or a Fresnel lens. Also, the reflector is either placed attached to the Fabry-Perot device or away from it for some distance so that the light intensity of the output spectra can have a feature of fine-tuning.

By using the design of the invention, the output spectra of the foregoing laser light source will be modified because of being affected by the center wavelength of the Fabry-Perot device. Therefore, by adjusting the gap between the parallel mirrors of the Fabry-Perot device, the laser light source can directly output light with desired spectra, which is achieved by the adjustment of the center wavelength of the Fabry-Perot device. Further, the tunable light source module of the invention is designed to let the mirror reflect the light beams first, and then the light beams will enter into the laser light source. Therefore, the light will pass through the Fabry-Perot device twice, which makes the laser light source emit light with extreme narrow bandwidth. The extreme narrow bandwidth have an effect on preventing the optical signals from entering the adjacent channels (ie, immune to crosstalk).

### BRIEF DESCRIPTION OF THE DRAWINGS

FIG. 1 is a schematic diagram of a conventional laser light source module.

FIG. 2 is a schematic diagram showing the configuration of a tunable light source module and the operating principle of the same, according to the first embodiment of the invention.

FIG. 3 is a schematic diagram showing the arrangement of the reflector having an adjustable tilt, according to the first embodiment of the invention.

FIG. 4 is a schematic diagram showing the configuration of the second embodiment of the invention and the operating principle of the same.

FIG. 5 is a schematic diagram showing the configuration of the third embodiment of the invention and the operating principle of the same.

### DETAILED DESCRIPTION OF THE PREFERRED EMBODIMENTS

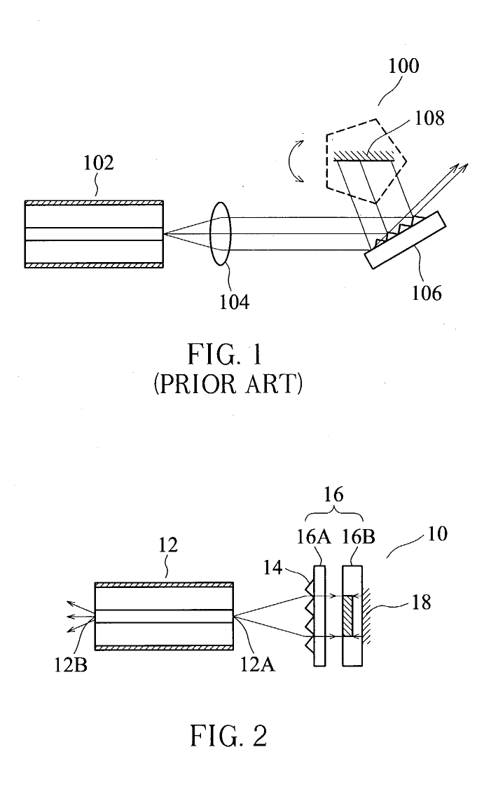

FIG. 2 shows a first embodiment of the tunable light source module 10. The module 10 includes a laser light source 12, a focusing lens 14, a tunable Fabry-Perot device 16, and a total reflection mirror 18. The laser light source 12 is a semiconductor light-emitting device, such as an AlGaAs laser diode and the like, which has two emitting surfaces 12A and 12B on each side of the device, and the emitting surface 12A is processed with an anti-reflection coating. The focusing lens 14 can be a convex lens, or a Fresnel lens composed of coplanar concentric rings. The Fabry-Perot device 16, preferably a MEMS-Fabry Perot filter fabricated by semiconductor processes, is placed between the laser light source 12 and the total reflection mirror 18. The Fabry-Perot device 16 forms with a cavity by disposing two parallel mirrors 16A and 16B with high reflection rate. As the cavity is an integral number of half wavelengths long, a stationary standing-wave pattern is produced. Thereby, the Fabry-Perot device 16 can output lightwaves at specific wavelengths within a range that are resonant.

The operating principle of the tunable light source module of the invention will be described according to the first embodiment below. First, when the light emitted from the emitting surface 12A of the laser light source 12 passes through the focusing lens 14, it is collimated to parallel light beams. After the light beams enter the Fabry-Perot device 16, most of the spectra of the light beams are filtered out except for the spectra that meet the resonant condition of the Fabry-Perot device 16. Next, by means of the total reflection mirror 18 attached to the backside of the reflection mirror 16B of the Fabry-Perot device 16, the light beams that have passed through the Fabry-Perot device 16 can pass through the same device again. After that, the light will be converged by the focusing lens 14 and returned to the laser light source 12. Since the emitting surface 12A has been processed with an anti-reflection coating, a great part of the light reflected by the total reflection mirror 18 can still enter the laser light source 12. Moreover, the mirrors 16A and 16B are designed to be movable so as to modulate the gap between the two mirrors. When the gap is modulated, the spectra that pass through the Fabry-Perot device will be changed immediately and only the specific spectra of the light beams that meet the resonant condition of the Fabry-Perot device 16 can return to the laser light source 12. Thereby, the tunable light source module 10 can instantaneously output light at specific spectra through the emitting surface 12B of the laser light source 12.

Through the design of the embodiment, the output spectra of the foregoing laser light source 12 will be changed because of being affected by the center wavelength of the Fabry-Perot device 16. Therefore, by adjusting the gap between the parallel mirrors of the Fabry-Perot device 16, the laser light source 12 can output light with desired spectra instantaneously, which is achieved by the adjustment of the center wavelength of the Fabry-Perot device 16. Moreover, after the light passing through a Fabry-Perot device 16 for the first time, its spectrum distribution tends to follow Gaussian distribution. After that, since the light is designed to pass through the Fabry-Perot device 16 again, the laser light source 12 can emit light with extreme narrow bandwidth.

As described above, the tunable light source module 10 of the embodiment is designed to let the mirror reflect the light beams first, and then the light beams will enter into the laser light source 12. Therefore, the light will pass through the Fabry-Perot device 16 twice, which makes the laser light source 12 emit light with extreme narrow bandwidth. The extreme narrow bandwidth has an effect on preventing the optical signals from entering the adjacent channels (ie, immune to crosstalk).

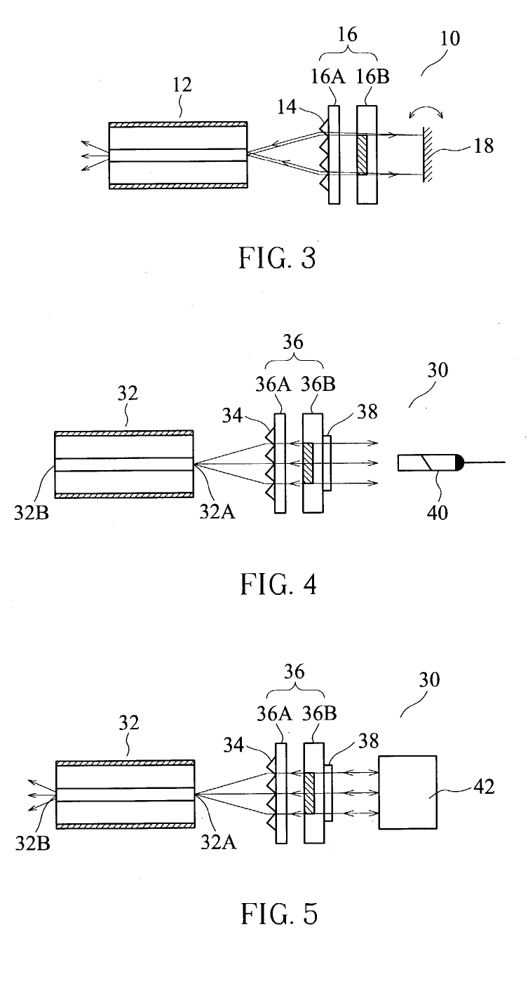

FIG. 3 is a schematic diagram showing the arrangement of the reflection mirror 18 having an adjustable tilt, according to the first embodiment of the invention. As shown in FIG. 3, the total reflection mirror 18 of the embodiment can alternatively not to be fixed on one side of the Fabry-Perot device 16. Instead, it can be placed away from the device for some distance so that the reflection mirror 18 can swing from left to right. Thus, by fine-tuning the tilt of the reflection mirror 18, the light intensity that returns to the laser light source 12 can then be fine-tuned and controlled. Consequently, when the tunable light source module 10 is used in optical fiber network for channel monitoring, the light intensity for each channel can be evenly kept due to the feature of fine-tuning.

FIG. 4 is a schematic diagram showing the configuration of second embodiment of the invention and the operating principle of the same. The tunable light source module 30 of the embodiment includes a laser light source 32, a focusing lens 34, a tunable Fabry-Perot device 36 and a partial reflection mirror 38 that transmits a portion of the light incident thereon and reflects the remainder, for example, transmits half of the light and reflects the other half. In the second embodiment, the emitting surface 32A of the laser light source 32 is processed with an anti-reflection coating, whereas the opposite emitting surface 32B is processed with a total reflection coating. As shown in FIG. 4, when the light emitted from the laser light source 32 arrives in the partial reflection mirror 38, a portion of the light is reflected and enters the Fabry-Perot device 36 again, and therefore the spectrum bandwidth of such portion of the light becomes narrower. Finally, the light with narrow bandwidth will pass through the focusing lens 34 and then enter the laser light source 32, and that will make the laser light source 32 emit light with a bandwidth that is even narrower. At this time, since the emitting surface 32B of the laser light source 32 is a total reflector, the light only emits from the emitting surface 32A, and the light will pass through the partial reflection mirror 38 that allows the light to be transmitted and then forms the output light of the tunable light source module 30. Also, due to the reflection mirror 38 being characterized by partial-reflected, the output light of the tunable light source module 30 will travel through the focusing lens 34 and form parallel light beams, which contributes to the application of a collimator 40 for receiving light beams so as to obtain a higher light intensity.

FIG. 5 is a schematic diagram showing the third embodiment wherein the emitting surface 32B functions as a partial reflector. As shown in FIG. 5, the emitting surface 32B of the laser light source 32 is processed with an optical thin film with partial reflection that allows the laser light source 32 to output light through it. Next, a wavelength locker 42 is provided, which allows the light to enter after passing through the partial reflection mirror 38. By use of such design, the light that passes through the partial reflection mirror 38 can return to the laser light source 32 after being processed by the wavelength locker 42. Hence, the laser light source 32 can output light with a desired wavelength more accurately.

Moreover, referring to what is shown in FIG. 3, the foregoing partial reflection mirror 38 can also adopt the method of fine-tuning the tilt of the mirror, and by doing so, the light intensity of the output light of the laser light source 32 can be fine-tuned.

Further, the focusing lens of the invention can either be separately formed on an optical substrate or on the side of the Fabry-Perot device facing the laser diode, by using etch processes.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A tunable light source module, comprising:
a semiconductor light-emitting device;
a tunable Fabry-Perot device for filtering light emitted from the semiconductor light-emitting device; and
a reflector for reflecting the light passed through the Fabry-Perot device back to the Fabry-Perot device again and subsequently making the light entering the semiconductor light-emitting device.

2. The tunable light source module as claimed in claim 1, wherein the semiconductor light-emitting device is a laser light source.

3. The tunable light source module as claimed in claim 1, further comprising a focusing lens placed between the semiconductor light-emitting device and the Fabry-Perot device for collimating the light emitted from the semiconductor light-emitting device.

4. The tunable light source module as claimed in claim 3, wherein the focusing lens is a convex lens.

5. The tunable light source module as claimed in claim 3, wherein the focusing lens is a Fresnel lens.

6. The tunable light source module as claimed in claim 1, wherein the reflector is fixed onto the Fabry-Perot device.

7. The tunable light source module as claimed in claim 1, wherein the reflector is placed away from the Fabry-Perot device.

8. A tunable light source module, comprising:
a semiconductor light-emitting device having a first and a second emitting surfaces;
a tunable Fabry-Perot device for filtering light emitted from the first emitting surface; and
a total reflector for reflecting the light passed through the Fabry-Perot device back to the Fabry-Perot device again and subsequently making the light entering the semiconductor light-emitting device;
wherein the tunable light source module outputs the light from the second emitting surface.

9. The tunable light source module as claimed in claim 8, further comprising a focusing lens placed between the semiconductor light-emitting device and the Fabry-Perot device for collimating the light emitted from the first emitting surface.

10. The tunable light source module as claimed in claim 8, wherein the first emitting surface of the semiconductor light-emitting device is processed with an anti-reflection coating.

11. A tunable light source module, comprising:
a semiconductor light-emitting device having a first and a second emitting surfaces;
a tunable Fabry-Perot device for filtering light emitted from the first emitting surface; and
a partial reflector for partially reflecting the light passed through the Fabry-Perot device back to the Fabry-Perot device again and subsequently making the light entering the semiconductor light-emitting device.

12. The tunable light source module as claimed in claim 11, further comprising a focusing lens placed between the semiconductor light-emitting device and the Fabry-Perot device for collimating the light emitted from the first emitting surface.

13. The tunable light source module as claimed in claim 11, wherein the first emitting surface of the semiconductor light-emitting device is processed with an anti-reflection coating.

14. The tunable light source module as claimed in claim 11, wherein the second emitting surface of the semiconductor light-emitting device is a total reflector, and the tunable light source module outputs the light that has passed through the partial reflector.

15. The tunable light source module as claimed in claim 14, further comprising a collimator for receiving the light passed through the partial reflector.

16. The tunable light source module as claimed in claim 11, wherein the second emitting surface of the semiconductor light-emitting device is a partial reflector, and the tunable light source module outputs light from the second emitting surface.

17. The tunable light source module as claimed in claim 16, further comprising a wavelength locker.
